(19) United States
(12) Patent Application Publication
(10) Pub. No.: US 2009/0038465 A1
(43) Pub. Date: Feb. 12, 2009

(54) DRUMS

(76) Inventors: John Whalley, Greater Manchester (GB); Thomas Philip Holding, Merseyside (GB)

Correspondence Address: THOMAS HOLDING, 37 DERBY STREET, NEWTON LE WILLOWS, MERSEYSIDE WA12 9QJ, WA12 9QJ, GB

(21) Appl. No.: 11/912,183

(22) PCT Filed: Apr. 21, 2006
(86) PCT No.: PCT/GB2006/001443

§ 371 Date: Oct. 22, 2007

(30) Foreign Application Priority Data
Apr. 22, 2005 (GB) 0508118.7
Aug. 12, 2005 (GB) 0516600.4

(51) Int. Cl. G10D 13/02

(52) U.S. Cl. 84/415

(57) ABSTRACT

A shell (1) for a drum comprises an outer layer (1a), an intermediate layer (1b) and inner layer (1c), wherein the intermediate layer has a plurality of larger apertures (2) and the inner layer has a plurality of smaller apertures (3) overlying the larger apertures.

This invention concerns improvements in and relating to drums and in particular to snare drums.

Modern snare drums as used by marching bands have become extremely complicated in attempts to improve performance but have also become much heavier. Therefore, they are difficult to carry and play for extended periods of time.

An object of this invention is to provide an improved drum, especially snare drum.

According to a first aspect of the invention there is provided a shell for a drum comprising an outer layer, an intermediate layer and inner layer, wherein the intermediate layer has a plurality of larger apertures and the inner layer has a plurality of smaller apertures overlying the larger apertures.

The larger apertures are preferably longer in the axial direction of the shell and preferably have parallel sides and arcuate top and bottom ends. The smaller apertures are preferably circular.

The layers of the shell are preferably contiguous.

The shell is preferably constructed from plywood.

According to a second aspect of the invention there is provided a drum, especially a snare drum comprising a shell and top and bottom skins mounted respectively over top and bottom edges of the shell, by means of upper and lower tensioning rings and means for drawing the tensioning rings towards each other to tension the skins, wherein the tensioning rings are not in direct contact with the shell.

The means for drawing the tensioning rings towards each other preferably comprises a plurality of radially spaced rods externally of the shell. Preferably a rod has a first end that is held by one of the tensioning rings and a second end that passes through the other ring and has means thereon for drawing the rod further through the other tensioning ring. The tensioning rod may have screw threading on said second end and the drawing means is preferably a screw threaded nut on the threaded end of the rod that bears against the tensioning ring.

Preferably the rods are arranged for minimal contact with the tensioning rings. Ideally, the rods are centred relative to holes through the tensioning ring through which they are located At said one end the rods may have an enlargement of conical shape that locates in a countersunk hole of the tensioning ring. For the second ends of the rods, preferably the screw threaded nut has a spigot that locates in a hole of the upper tensioning ring to separate the rod from the ring.

The tensioning rods may be provided with sleeves, such as of plastics, especially framed plastics material. Such sleeves may be desirable for clamping.

By having minimal contact between the tensioning rods and rings, the resonance of the drum may be improved.

The shell of the second aspect of the invention is preferably a shell of the first aspect of the invention. Preferably each tensioning rod will be aligned between said adjacent apertures of a layer of the shell.

Preferably the shell is provided with a bearing edge, over which a skin is stretched. The bearing edge may be provided by shaping of the top or bottom edges of the shell, such as to provide an apex. Alternatively, a bearing ring may be fitted to an edge of the shell. The bearing ring preferably provides an apex The bearing edge or ring preferably has an outer side that has a curved surface. The bearing ring is preferably made of aluminium or steel. In one preferred embodiment a bearing edge may be formed by providing a groove in a top or bottom of the shell, inserting a metal ring, say of aluminium or steel and shaping the top or bottom of the shell to provide an apex.

According to a third aspect of the invention there is provided a snare drum comprising a shell and top and bottom skins tensionable on the shell and a snare apparatus, wherein the snare apparatus for the top skin comprises snare wires between a first mounting and an adjustable second mounting for adjusting the tension of the snare wires and the proximity thereof to the skin.

The upper snare apparatus locates the snare wires against the underside of the top skin, so that access to an adjusting mechanism is provided through an aperture or apertures through shell.

The preferred means for adjusting the tension and positioning of the snare wires comprises a bell crank mechanism. Preferably a bell crank mechanism is provided at both ends of the snare wires.

According to a fourth aspect of the invention there is provided a snare drum comprising a shell and top and bottom skins tensionable on the shell and a snare apparatus, wherein the snare apparatus for the bottom skin comprises snare wires coupled to a tensioning ring for the skin, at least one of said coupling means being arranged for tensioning the snare wires.

The preferred coupling tensioning means comprises a pivotable plate coupled at one end to the snare wires and extending over a fulcrum to adjustment means for changing the angle of the plate to increase or decrease the tension on the snare wires. The means for changing the angle of the plate is preferably a screw that extends through an aperture of the plate into a threaded hole of a block or the like, which preferably also is shaped to provide the fulcrum.

By having the bottom snare apparatus connected to the tensioning ring for the bottom skin, the tensioning ring and snare apparatus can be removed and replaced as a unit for enabling replacement of the skin.

The shell for the third and fourth aspects of the invention is preferably a shell of the first aspect of the invention. Furthermore, the third and fourth aspects of the invention preferably have skin tensioning means of the second aspect of the invention.

According to a fifth aspect of the invention there is provided a snare drum comprising a shell and top and bottom skins mounted respectively over top and bottom edges of the shell, wherein at least one edge of the shell is provided with a metal annulus which provides, at least in part, a bearing edge of the drum.

Preferably both the top and bottom edges of the shell are provided with the metal annulus that provides the bearing edge. Suitably, the bearing edge fits over an edge of the shell. Alternatively, the bearing edge may be received within the shell, a portion of the bearing edge protruding beyond the shell. Suitably, the shell is formed from a plurality of layers, inner layers of the shell extending less far than outer layers, thereby providing a recess which receives the metal annulus. Preferably, the metal annulus is provided with a curve or slope. Preferably, the curve or slope is continued through one or more layers of the shell. Preferably, the metal annulus is arranged such that when it is under compression it does not press directly against at least one of an inner or outer layer of the shell.

According to a sixth aspect of the invention there is provided a snare drum comprising a shell and top and bottom skins mounted respectively over top and bottom edges of the shell, wherein the snare drum further comprises a snare and snare tension adjustment apparatus, the snare tension adjustment apparatus being arranged to urge at least part of the snare in the direction of one of the skins of the drum.

Preferably, the adjustment apparatus comprises a bracket which is arranged to undergo some rotation when force is applied to the bracket. Preferably, the bracket is connected to a link which is arranged such that when it is tensioned it causes the bracket to rotate. Preferably the link is flexible. Preferably, the apparatus is fixed to a tensioning ring of the drum. Preferably, the bracket is curved, and the link passes through the bracket in two locations.

According to a seventh aspect of the invention there is provided a drum carrier, the drum carrier comprising an arcuate member and at least one limb, the arcuate member being dimensioned such that it will pass around at least part of a tensioning ring of a snare drum and being provided with fixing means which protrude from the arcuate member to engage with the drum. Preferably, the fixing means is arranged to engage with the tensioning ring. Preferably, the fixing means are pointed. Preferably the fixing means are screws. Preferably, the at least one limb is arranged to depend from the arcuate member. Preferably, the at least one limb is provided with a blade, or other tapered structure, which is positioned to engage with a lowermost tensioning ring of a snare drum held by the carrier. Preferably, the at least one limb is pivotally mounted on the arcuate member. Preferably, the drum carrier is provided with an adjustment mechanism arranged to rotate the at least one limb about the pivot. Preferably, the arcuate member is dimensioned such that it extends less than 180° around a perimeter of a drum carried by the carrier.

This invention will now be further described, by way of example only, with reference to the accompanying drawings, in which:

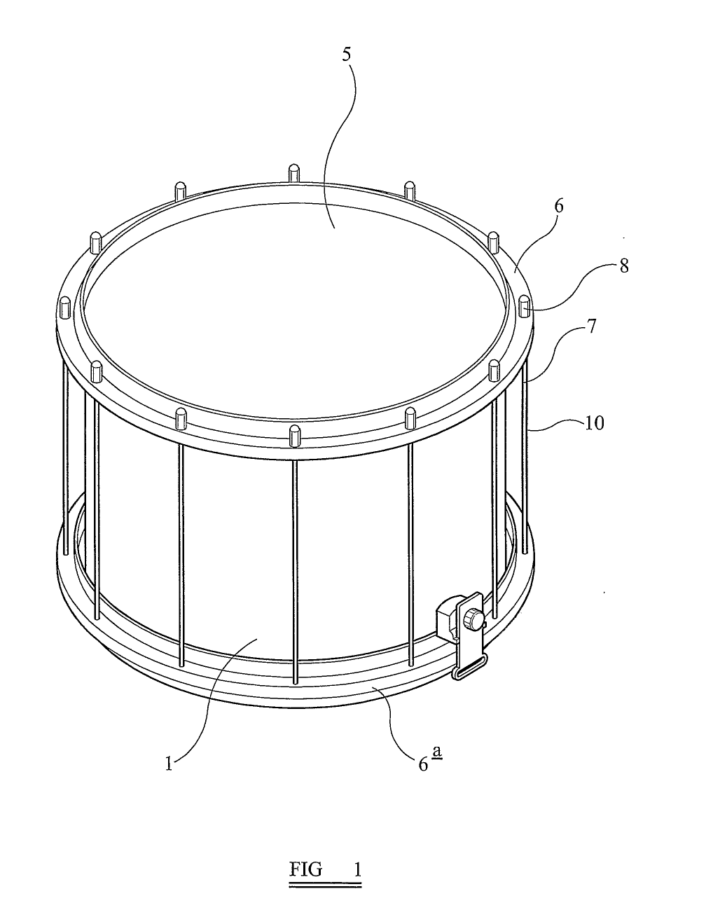

FIG. 1 is a perspective view of a drum according to the invention;

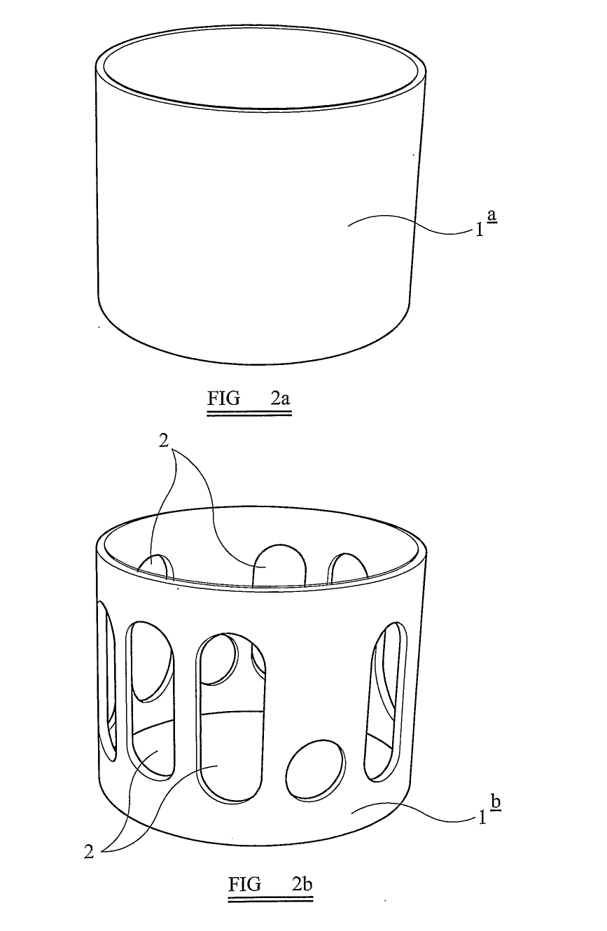

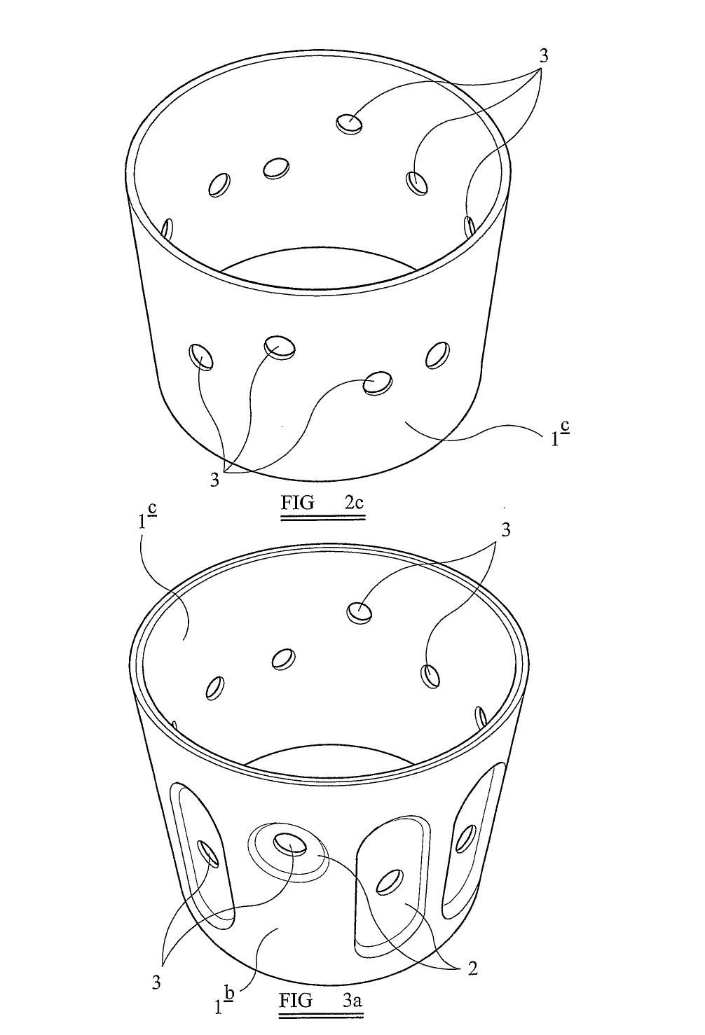

FIGS. 2a, 2b and 2c show outer, intermediate and inner layers of a shell for the drum of FIG. 1;

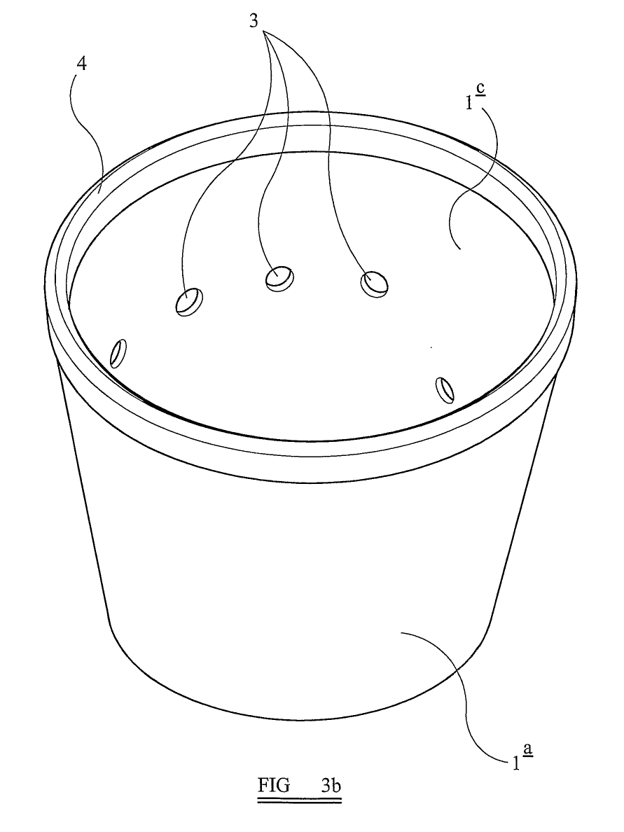

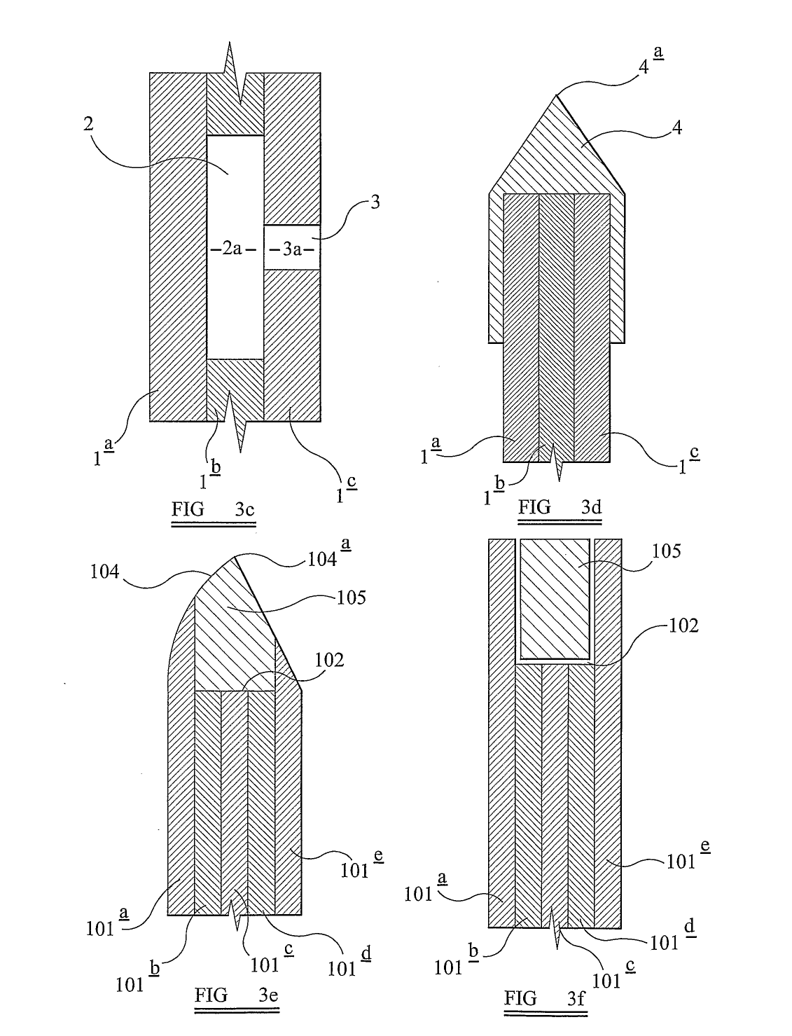

FIG. 3a shows the inner and intermediate layers of the shell assembled;

FIG. 3b shows the assembled shell;

FIG. 3c is a section through the shell;

FIG. 3d is a section through a top part of the shell;

FIG. 4 shows a skin tensioning system;

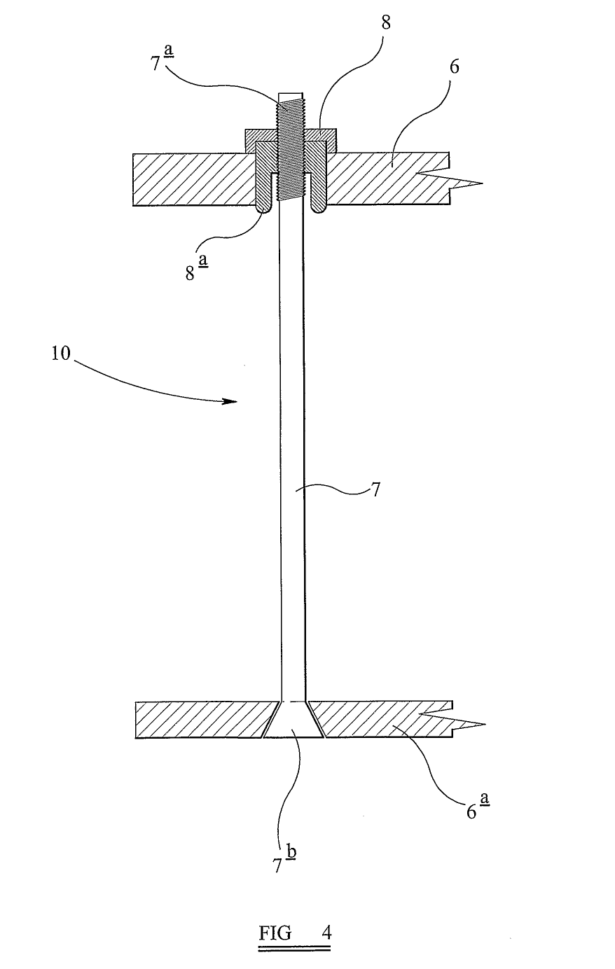

FIGS. 5a and b show a top skin snare arrangement;

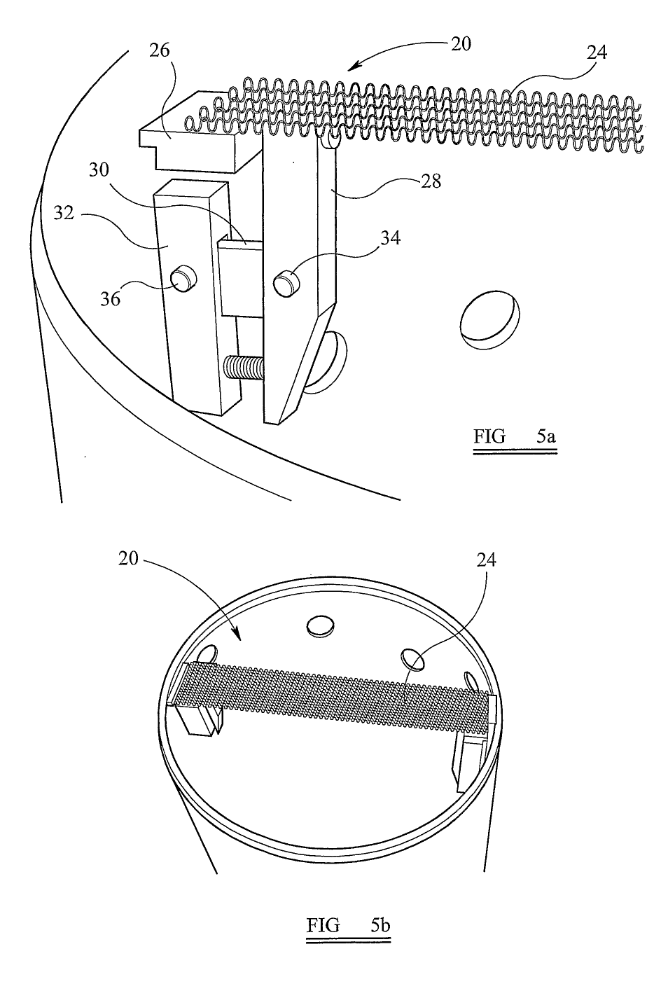

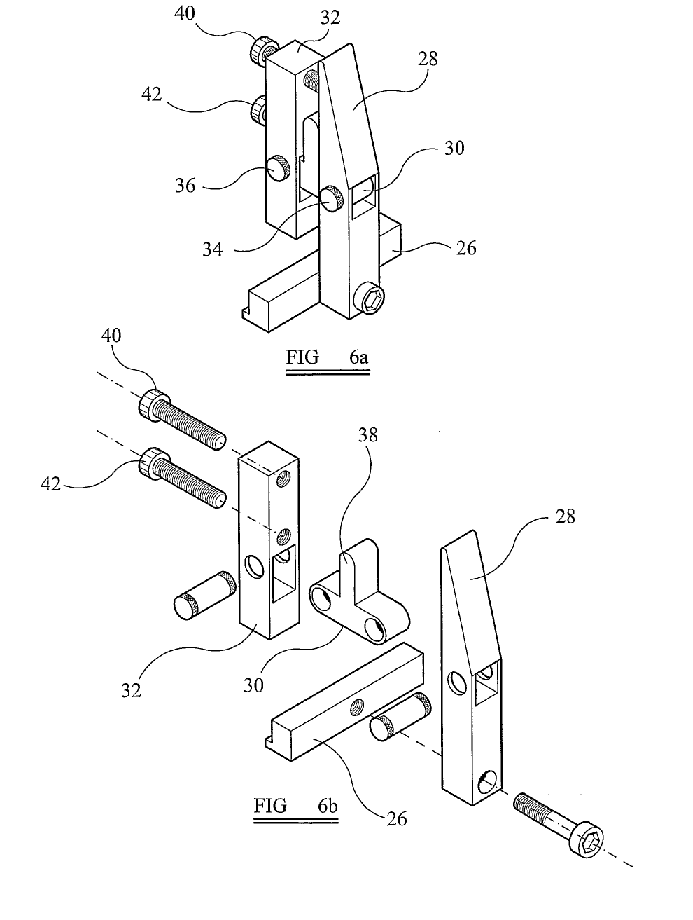

FIGS. 6a and b are assembled and exploded views of a tensioner for the top skin snare arrangement;

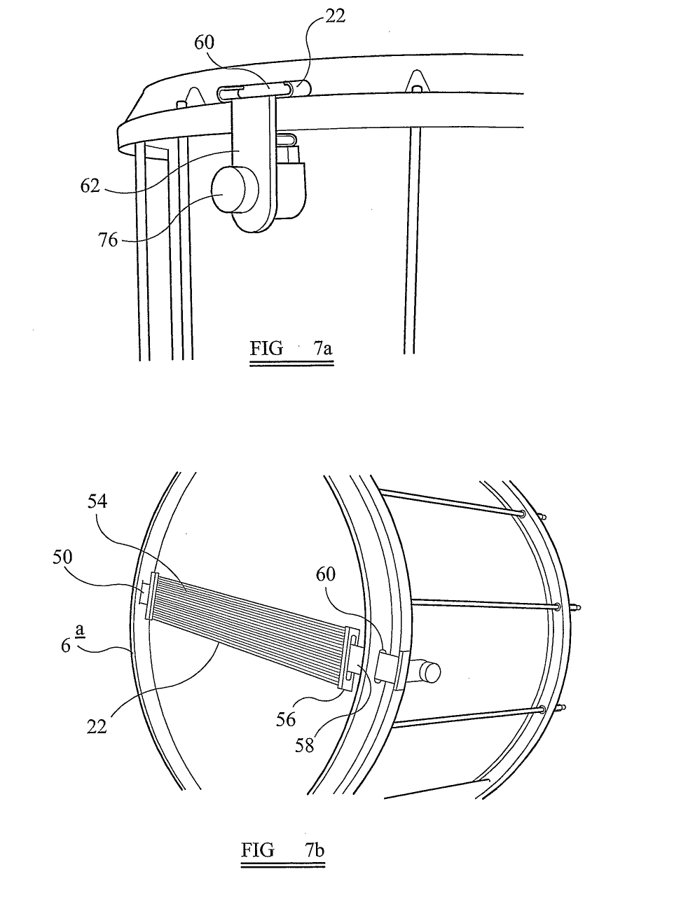

FIGS. 7a and b show a bottom skin snare arrangement; and

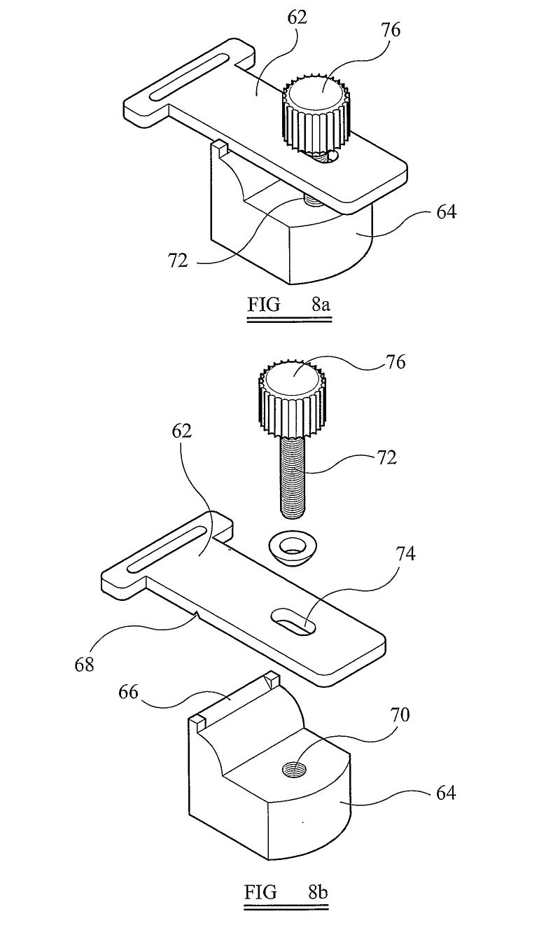

FIGS. 8a and b are assembled and exploded views of a tensioner for the bottom snare arrangement.

FIG. 1 shows a perspective view of a drum in accordance with an embodiment of the present invention. The drum comprises a shell 1, top and bottom skins 5 and a tensioning system 10.

The shell 1 is a composite structure, and comprises three independent nested shells, illustrated in FIGS. 2a to 2c. FIG. 2a shows an outer shell 1a, which is a hollow cylinder with no holes in its cylindrical wall. FIG. 2b shows an intermediate shell 1b, which has a plurality of large holes 2 in its cylindrical wall. FIG. 2c shows an inner shell, which has a plurality of small holes 3 in its cylindrical wall. The number and position of large holes 2 in the intermediate shell 1b correspond to the number and position of the small holes 3 in the inner shell 1c. The inner and outer diameters of the outer, intermediate and inner shells 1a, 1b, 1c are such that the inner shell 1c can be nested snugly in the intermediate shell 1b, and such that the intermediate shell 1b can be nested snugly in the outer shell 1a.

The inner, intermediate and outer shells are formed from plywood. The holes 2, 3 in the intermediate shell 1b and inner shell 1c may be made by cutting into the cylindrical walls of the shells 1b, 1c with an electric saw or the like.

FIGS. 3a and 3b show how the outer, intermediate and inner shells 1a, 1b, 1c are nested to form the composite structure of the shell 1. FIG. 3 a shows the inner shell 1c nested inside the intermediate shell 1b. It can be seen that the centre position of the small holes 3 of the inner shell 1c coincide with the centre position of the large holes 2 of the intermediate shell. The nested inner and intermediate shells 1c, 1b are then nested within the outer shell 1a, as shown in FIG. 3b.

It can be seen from FIG. 3c that, in nesting and aligning the shells 1a, 1b, 1c in the aforementioned manner, the aligned holes 2, 3 form a plurality of resonance chambers 2a and chamber entrances 3a. The resonance chambers 2a act to increase the ‘quality’ of the sound emitted by the drum (when struck). For example, the chambers serve to increase the resonance of the drum.

The nested shells 1a, 1b, 1c are bound together with a fixing agent, such as a glue. Preferably, the fixing agent has similar acoustic properties to the material constituting the shells 1a, 1b, 1c, such that the acoustic properties of the drum are not compromised, for example, severely damping the resonance of the drum when struck. Most preferably, the fixing agent is chosen to have suitable acoustic properties for a desired acoustic performance of the drum.

Referring back to FIG. 3b, after the nested shells 1a, 1b, 1c have been bound together, a bearing edge 4 is attached to the composite shell 1. The bearing edge 4 is a shaped ring made of aluminium or steel, and is described in more detail in relation to FIG. 3d.

FIG. 3d shows the bearing edge 4 in cross section. The bearing edge 4 is shaped so that it forms a point 4a and is able to bridge the ends of the nested shells 1a, 1b, 1c. The point 4a improves the transmission of vibrations from the skin of the drum to the shell 1.

The bearing edge 4 forms a tight fit over the ends of the nested shells 1a, 1b, 1c, and is bound to the shells 1a, 1b, 1c with a fixing agent, such as glue. The fixing agent may have suitable acoustic properties, as described above. The bearing edge 4 may also serve to securely bind the ends of the nested shells 1a, 1b, 1c which it bridges.

It will be appreciated that the bearing edge 4 is not essential. The ends of the nested shells 1a, 1b, le can be shaped so as to form the aforementioned point 4a. However, the use of an independent bearing edge 4 is preferable, as it allows easy maintenance of the point 4a, for example simply by replacing a worn bearing edge 4 with a new one.

An alternative bearing edge is shown in FIG. 3e. In this embodiment, there are five independent nested shells 101a-101e. The shells 101a-101e are nested snugly within one another and bound together with a fixing agent, such as a glue, in a manner analogous to that described in relation FIGS. 2a to 2c and FIGS. 3a to 3c. A recess 102 is formed at an upper end of the nested shells 101a-101e by virtue of the fact that the innermost shell 101e and the outermost shell 101a extend beyond the inner shells 101b-101d. A bearing edge 104 comprising an annulus of metal 105 is located within the recess 102. The bearing edge 104 is shaped so that it forms a point 104a.

An outermost surface of the bearing edge 104 (i.e. the edge exterior of the point 104a) is curved as shown in FIG. 3e. The curvature of the bearing edge 104 is continued through an uppermost end of the outermost shell 101a. The curve is smooth such that there is no significant discontinuity between the outermost shell 101a and the bearing edge 104. The profile of the curve is such that the skin 5 of the drum (not shown in FIG. 3e) is in contact with both the metal annulus 105 and the outermost shell 101a of the drum. This is believed to provide the drum with good acoustic properties. It will be appreciated that other curve profiles may be used.

An innermost surface of the metal annulus 105 (i.e. the surface which is inside of the point 104a) is sloped. The slope is not curved but rather is straight, and is continued through an uppermost end of the innermost shell 101e. The slope is smooth such that there is no significant discontinuity between the innermost shell 101e and the bearing edge 104. The angle of the slope is typically 45 degrees relative to the side of the innermost shell 101e, as this is believed to provide the drum with good acoustic properties. It will be appreciated that other angles of slope may be used.

FIG. 3f illustrates the manner in which the bearing edge is constructed. The nested shells 101a-101e are bound together with a fixing agent, such as glue, in the manner described further above. The height of the inner shells 101b-101d is less than that of the outermost and innermost shells 101a, 101e, such that the recess 102 is formed when the shells are bonded together. The metal annulus 105 is inserted into the recess 102. The metal annulus 105 has a rectangular cross section, and has a depth which corresponds with the depth of the recess 102 (this may for example be 10 mm). In general, the metal annulus 105 is dimensioned such that it fits, together with a fixing agent, tightly into the recess 102 leaving no space between it and the nested shells 101a-101e. The metal from which the bearing edge is formed may be for example aluminium or steel, or maybe an alloy.

Once the metal annulus 105 had been secured in place, the ring together with inner and outer shells 101a, 101e are machined in order to form the bearing edge 104 with the shape as shown in FIG. 3e (or an alternative shape). As mentioned further above, there is no significant discontinuity between the metal ring 104a and the inner and outer shells 101a, 101e.

The bearing edge 104 of FIG. 3e is believed to provide improved sound transfer from the skin of the drum to the shell. Whereas with a multi plywood bearing edge, as seen in prior art drums, the sound transfer from the skin is to the layers in contact with the skin only, the embodiment of the invention is believed to directly transfer sound to all layers of the shell which are in contact with the bearing edge 104.

An equivalent bearing edge is provided at the bottom of the drum, to support a skin provided at the bottom of the drum. A further benefit of the embodiment of the invention is that, whilst the inner shells 101b-101d are in a state of compression (they are pushed together between the bearing edges), the inner most and outer most shells 101a, 101e are not directly pushed together by the bearing edges. Instead, the inner and outer shells 101a, 101e are pulled together by virtue of their being bonded to the inner layers l01b, 101d. This modified state of compression is believed to provide an enhancement of the tonal resonance of the drum.

A benefit of having a metal bearing edge, for example as illustrated in the above described embodiments, is that it helps to maintain the circularity of the drum.

FIG. 4 shows the skin 5, secured to the shell 1 by the tensioning system 10. The tensioning system 10, comprises top and bottom tensioning rings 6, 6a, and tensioning rods 7. The tensioning rods 7 are threaded at one end 7a and have an enlargement 7b at the other end. The tensioning ring 6 has apertures through which the tensioning rods 7 extend to receive threaded nuts 8. The nuts 8 have spigots 8a extending into their respective apertures. The bottom tensioning ring 6a has countersunk apertures for receiving the tensioning rods 7 and accommodating the enlargements 7b.

To tension both top and bottom skins 5 at the same time, the threaded nuts 8 are tightened on the tensioning rods 7, which pulls the tensioning rings 6, 6a towards each other to bear onto the rings of the skins, which are thus tightened over the bearing edge 4.

The skins 5 separate the nested shells 1a, 1b, 1c from the tensioning rings 6, 6a, i.e. the tensioning rings 6, 6a are not in direct physical contact with the nested shells 1a, 1b, 1c. This reduces the damping effect the tensioning rings 6, 6a may have on vibrations in the shell 1, and therefore improves the resonance of the drum.

The provision of the spigot 8a minimises the contact between the rods 7 and the tensioning rings 6, 6a. This reduces the transmission of any vibrations from the rods 7 to the tensioning rings 6.

By incorporating nested shells to produce resonance chambers 2a (see FIG. 3c), the sound produced by the drum is improved. The resonance chamber 2a is shown in relation to the embodiment which comprises three shells 1a, 1b, 1c. However, it will be appreciated that a resonance chamber may be formed within any number of shells. All that is required is that the hole in the innermost shell 1c, 101e is smaller than that provided in inner shells 1b, 101b-101d. T

The sound produced by the drum is improved by providing a ‘floating shell’ 1, i.e. a shell 1 that has no direct physical contact with the tensioning system 10 (i.e. the tensioning rings 6, 6a or rods 7). In prior art snare drums it was known to provide a floating shell for ‘low tension’ drums, i.e. drums which used naturally occurring skins rather than skins made from manmade materials such as Kevlar. However, the increased tension provided by manmade materials, in so called ‘high tension’ drums was such that bracing brackets were needed in the shell, which were connected to tensioning rods of the tensioning system. The embodiment of the invention, since it includes a metal bearing edge, is better able to take the strain of the tensioning system and does not require bracing brackets. It is this which allows the shell 1 to be free floating.

The drum has snare apparatus for the top and bottom skins, as will be described in relation to FIGS. 5 to 8. The top snare apparatus 20 is mounted within the shell to bear against the underside of the skin. The bottom snare apparatus 22 is mounted to the bottom tensioning ring 6a to bear against the underside of the bottom skin.

The top snare apparatus 20 comprises a plurality of snare wires soldered at opposite ends to mounting blocks 26. Each block 26 is fixed near one end of a moveable finger 28 connected by a bell crank 30 to a mounting 32 on the inside of the shell. The bell crank 30 is generally T-shaped having a pivoting connection 34, 36 at each end of the cross bar of the T-section and the stem of the T-section providing an actuating arm 38. The mounting 32 has first and second adjustment screws 40, 42. The first adjustment screw 40 which acts against the finger 28 at an end remote from the snare wire mounting block 26. The second adjustment screw 42 acts against the bell crank actuating arm 38.

The first adjustment screw 40 acts against the finger 28 to pivot it relative to the pivoting connection 34 of the bell crank to increase the tension on the snare wires 24. The second adjustment screw 42 acts against the actuating arm 38 of the bell crank to pivot same relative to the pivoting connection 36 of the bell crank to the mounting 32 and hence to move the finger 28 upwards or downwards or alter the extent of contact between the snare wires and the underside of the skin of the drum.

The bottom snare apparatus 22 comprises a fixed mounting point 50 at one end and an adjustable mounting point 52 at the other end diametrically opposed on the lower tensioning ring 6a. The snare wires 54 are attached at each end to a mounting plate 56. The mounting plate 56 at the adjustable end 52 is connected by a flexible link 58 that passes through an aperture 60 of the tensioning ring to a pivot plate 62. A block 64 is attached above the tensioning ring 6a and is shaped to provide a fulcrum 66 over which the pivot plate 62 pivots. The pivot plate 62 has a transverse groove 68 to locate it on the fulcrum 66. The block 64 also has a threaded hole 70 to receive an adjustment screw 72 that passes through an aperture 74 of the pivot plate 62. By screwing the adjustment screw 72 into the block 64 its head 76 acts against the pivot plate 62 to pivot its end, to which the flexible link 58 is attached, outwards of the drum to tension the snare wires.

The position of the aperture 74 in the tensioning ring relative to the skin of the drum is such that, when the snare wires are being tensioned, they will also be drawn closer to the skin.

An advantage of mounting the snare 22 to the tensioning ring 6a is that the tension exerted by the snare pulls against the tensioning ring, which is sufficiently strong to resist deformation. In prior art drums, where the snare is mounted to the shell of the drum, the tension exerted by the snare tends to pull opposite sides of the drum towards one another, thereby deforming the drum. Commonly, a metal rod extends parallel to the snare in prior art drums, to brace the sides of the drum and prevent it from deforming. The tensioning ring is sufficiently rigid that it prevents significant distortion of the drum, even in the absence of a bracing rod. Since the metal rod is no longer required, this reduces the weight of the drum. Furthermore, strengthening brackets are no longer needed for the drum shell, thereby further reducing the weight of the drum.

It will be appreciated that in addition to the embodiment shown in FIGS. 7 and 8, other forms of snare mounting may be attached to the tensioning ring. For example, the mounting may include a lever based adjustment mechanism for adjusting the tension of the snare. The lever based adjustment mechanism may be similar to those already known for snare drums; the difference being that the mechanism is secured to the tensioning ring rather than to the shell of the drum. Other alternative mountings will be apparent to those skilled in the art.

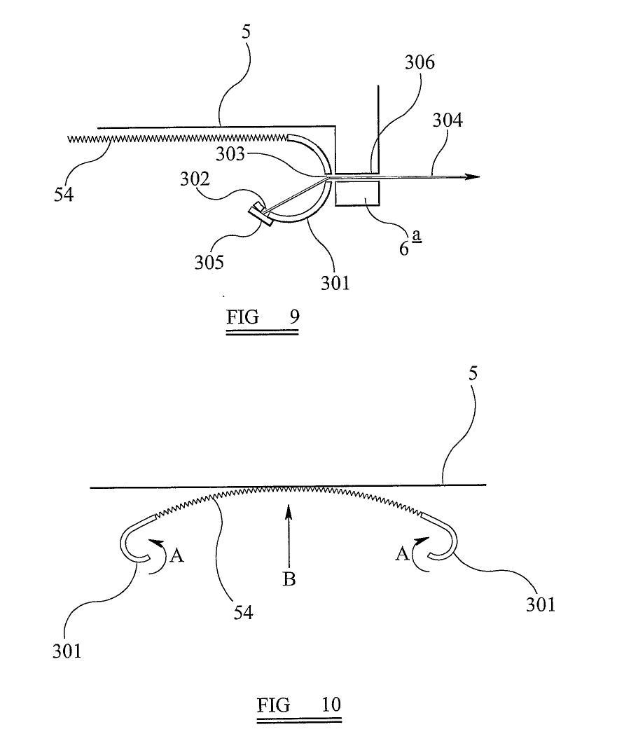

An alternative mounting for the bottom snare apparatus 22 is illustrated schematically in FIG. 10. The lower tension ring 6a of the drum and drum skin 5 are shown schematically, together with snare wires 54 which are attached to a curved bracket 301. The curved bracket 301 is provided with a lower slot 302 and an upper slot 303 which are dimensioned to receive a flexible link 304. The flexible link 304 is provided at one end with a stopper 305, and passes though the lower slot 302 then through the upper slot 303, and thereafter through a slot 306 provided in the tensioning ring 6a. The flexible link 304 passes to an adjusting apparatus (not shown), which is arranged to adjust the tension on the flexible link 304. A corresponding mounting is provided at an opposite side of the drum.

The effect of the mounting is shown schematically in FIG. 10. Due to the curved configuration of the brackets 301, applying tension to the flexible link 304 causes the brackets to rotate as shown by arrows A. This in turn causes the snare wires 54 to curve upwards towards the drum skin 5, as shown by arrow B.

An advantage of the adjustment mechanism is that it pushes the snare wires 54 upwards against the force of gravity. This is believed to provide an improved contact between the snare wires 54 and the drum skin 5, as compared with prior art adjustment mechanisms which merely tension the snare wires and do not curve them towards the drum skin.

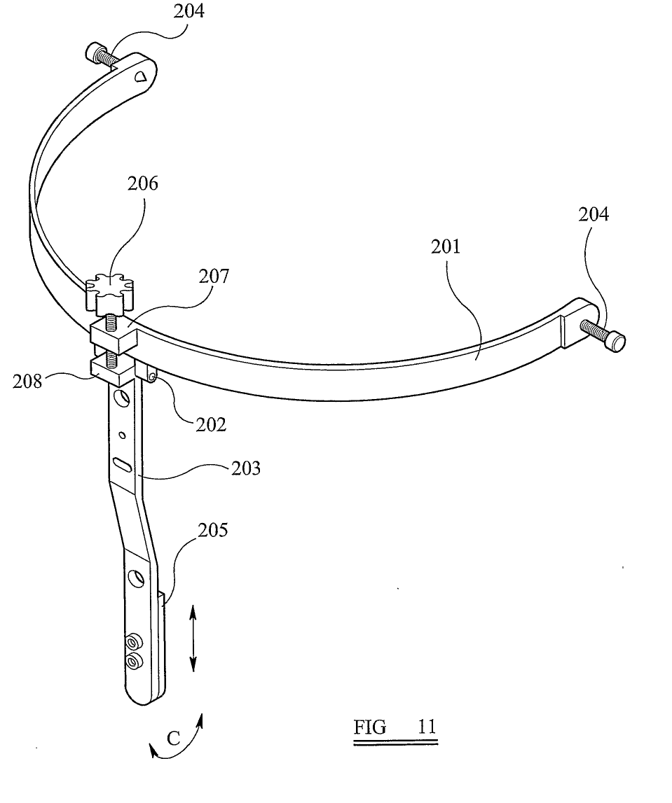

An drum carrier for carrying a drum is shown in FIG. 11. The carrier comprises an arcuate member 201, which is connected via a pivot 202 to a limb 203. The arcuate member 201 is configured such that it will pass around a top tensioning ring of a drum (a top tensioning ring is shown in FIG. 1). The arcuate member 201 is provided with screws 204 at either end. The screws 204 are pointed, and are arranged such that in use they may be screwed into suitably positioned recesses provided on the upper tensioning ring. The arcuate member may be for example 5 mm by 20 mm in section, with a diameter of approximately 16 inches.

A lowermost end of the limb 203 is provided with a blade 205, which in use pushes against a lower tensioning ring 6a of the drum. The blade 205 is used in preference to a screw, since it allows drums of different depth to be fitted to the carrier.

An adjusting screw 206 passes through a first bracket 207 provided on the arcuate member and a second bracket 208 provided at an upper end of the limb 203. The brackets 207, 208 and the adjusting screw 206 are arranged such that the angle at which the limb 203 extends, relative to a plane defined by the arcuate member 201, may be adjusted. This is illustrated in FIG. 5 by arrow C.

The carrier is attached to straps (not shown), which are worn by a drummer. The arcuate member 201 preferably extends through less than 180 degrees around the perimeter of the upper tensioning ring 6, with the effect that the centre of gravity of the drum is slightly in front of the screws 204. The drum will therefore rotate, the outer portion of the drum moving downwards, until it pushes against the knife edge 205. The rotation angle of the drum with respect to the arcuate member 201 is adjusted using the adjusting screw 206.

An advantage of the carrier shown in FIG. 5 is that it has only 3 small points of contact with the drum, i.e. the pointed screws 204 and the blade 205. This is advantageous because it allows the drum to resonate more freely, as compared with prior art drum carriers which use padding that extends around a significant proportion of the drum.

A further advantage of the drum carrier is that it allows the drum to be rotated about a pivot axis provided by the screws 204, such that the drum may be inverted. This is useful because it allows a drummer to inspect the bottom snare of the drum. Visual inspection of the snare allows the snare to be accurately adjusted (the tension of the snare affects the sound produced by the drum). Prior art drum carriers did not allow the drum to be inverted, and inspection of the tension of the snare was not done visually, but by the drummer feeling the tension of the snare with his or her fingers.

It will be appreciated that the drum carrier may be used to carry drums other than snare drums.

1-29. (canceled)

30. A snare drum comprising a shell and top and bottom skins mounted respectively over top and bottom edges of the shell, by means of upper and lower tensioning rings and means for drawing the tensioning rings towards each other to tension the skins.

31. A snare drum comprising a shell and top and bottom skins tensionable on the shell and a snare apparatus, wherein the snare apparatus comprises snare wires coupled to a tensioning device.

32. A snare drum comprising a shell as claimed in claim 1 and top and bottom skins tensionable on the shell and a snare apparatus, wherein the snare apparatus for the bottom skin comprises snare wires coupled to a tensioning ring for the skin, at least one of the said coupling means being arranged for tensioning the snare wires.

33. A snare drum as claimed in claim 32, wherein the coupling tension means comprises a pivotable plate coupled at one end to the snare wires and extending over a fulcrum to adjustment means for changing the angle of the plate to increase or decrease the tension of the snare wires.

34. A snare drum as claimed in claim 33, wherein the means for changing the angle of the plate is a screw that extends through an aperture of the plate into a threaded hole of a block or the like, which is shaped to provide a fulcrum.

35. A snare drum comprising a shell and a top and bottom skins mounted respectively over top and bottom edges of the shell, wherein the snare drum further comprises a snare and a snare tension adjustment apparatus, the snare tension adjustment apparatus being arranged to urge at least part of the snare in the direction of one of the skins of the drum.

36. A snare drum as claimed in claim 35, wherein the snare tension adjustment apparatus comprises a bracket, which is arranged to undergo some rotation when force is applied to the bracket.

37. As claimed in claim 36, wherein the bracket is connected to a link, which is arranged such that when it is tensioned it causes the bracket to rotate.

38. A snare drum as claimed in 37, wherein the link is flexible.

39. A snare drum as claimed in claim 35, wherein the snare tension adjustment apparatus is fixed to a tensioning ring of the drum.

40. A snare drum as claimed in claim 37, wherein the bracket is curved, and the link passes through the bracket.
